(19) United States
(12) Patent Application Publication
(10) Pub. No.: US 2022/0330515 A1
(43) Pub. Date: Oct. 20, 2022

(54) KIT OF REPLACEABLE CAT LITTER FILTERS AND METHOD OF USING SAME

(71) Applicant: Murray Scott THOMSON, Beaumont (CA)

(72) Inventor: Murray Scott THOMSON, Beaumont (CA)

(21) Appl. No.: 17/232,194

(22) Filed: Apr. 16, 2021

(51) Int. Cl. A01K 1/01; B65D 33/28; B65D 30/00; B65F 1/00

(52) U.S. Cl. CPC A01K 1/0114; B65D 33/28; B65D 29/00; B65F 1/002; B65F 2250/105

(57) ABSTRACT

Various embodiments of the invention relate to a kit that makes cleaning cat litter boxes easier and more hygienic. The kit comprises numerous stacked filter sheets that can be gathered to form an enclosed bag by use of a drawstring that is threaded around the outer circumference of the filter sheet. Clean litter falls through the filter sheets and the soiled litter can be discarded along with the uppermost of the stacked filter sheets.

### FIELD OF THE INVENTION

The present invention relates generally to the field of pet hygiene, specifically to the cleaning of pet litter boxes, more specifically to a device that filters used cat litter from clean cat litter.

### BACKGROUND

Domestic animals, typically cats, commonly use litter boxes filled with litter for their bathroom duties. Consequently, the used litter must be regularly removed from the litter box. This change of uses litter is an unpleasant task for cat owners. Typically, litter is cleaned using a perforated shovel to filter litter to keep and re-use clean litter and dispose of soiled litter.

Numerous different methods have been attempted to make the task of cleaning cat litter boxes less onerous, as summarized below.

WO2015067885 discloses a filtering bag for a cat litter comprising: an upper part defining an upper edge delimiting an opening of the bag; a lower part defining a lower edge where the bag is hermetically sealed, and an intermediate part between the upper part and the lower part provided with perforations intended to filter the litter, the bag being foldable between a screen configuration for filtering the litter through the perforations, and a pocket configuration for transporting the litter hygienically, the bag further comprising a removable hooking means for keeping the bag in the screen configuration.

US20090194033 discloses an array of disposable mesh liner bags that are removably attached to a rigid flat insert that is held in place with retainers in the bottom of a pet litter box. Each bag has a center mesh and peripheral draw string to lift each bag individually. Litter is sifted through the mesh and solid waste lifted out and tied up in the bag for disposal. A solid mesh bag at the bottom of the array lifts out all of the litter after the top bags have all been used.

U.S. Pat. No. 4,784,082 discloses a cat litter box system including a tray which may have inwardly canted edges and a waterproof bottom. Inserted in the tray is at least one orificed filter sheet, and preferably several, having some type of corner or edge lifting means. The top a stack of disposable feces filters is grasped by integral handles and extracted from the litter box, filtering by such extraction the solid waste from the granular litter material which remains within the box. Within each disposable feces filter is a centrally located matrix orifices. Each disposable feces filter preferably incorporates extension plastic strips, or string-like elements at its four corners. These elements enable the filter to be extracted from within the litter tray.

U.S. Pat. No. 4,615,300 discloses a litter box liner including a plurality of removable layers stacked one inside of the other and conformable to the shape of the interior surface of a litter box. The liner includes an imperforate bottom layer and a plurality of screening layers positioned above the bottom layer. Each screening layer includes a bottom wall with a plurality of openings therethrough which are large enough to pass granular litter but small enough to block animal excrement.

U.S. Pat. No. 5,207,772 discloses a litter box liner system and method for use with an animal waste litter box and litter material having separably attached layers of perforated filters which line the bottom of the box over which litter material is spread. Periodic removal of each filter recirculates the litter material from the bottom up and catches solid waste for convenient and sanitary disposal. An unperforated bottom layer lines and protects the interior of the litter box from contact with the litter material and captures all of the litter material for convenient and sanitary disposal. The separably attached layers of perforated filters may be individual sheets or incorporated into individual inter-fitting filter liner bags which fit over the litter box and contain solid waste upon removal.

U.S. Pat. No. 5,752,466 discloses a liner-sieve system for use with a litter box which employs litter of the clumping type. The system includes a cassette having a plurality of flexible liner sheets stacked over the litter box with an expandable or stretchable netting secured to a surface of each liner sheet disposed in a central area of the box. A releasable flap in the form of a slit is formed in each liner sheet beneath the netting. The liner sheets are fused together at peripheral edges which can be draped over the wall of the litter box, and the liner sheets are perforated adjacent the peripheral edges for separation of an uppermost liner sheet from the next lower liner sheet. Clumping litter disposed in the central area opens the flap to allow the un-clumped litter to sift through the netting onto the next lower liner sheet. The clumped litter and feces are retained in the liner and netting material for convenient disposal. The flap generally inhibits litter from passing through the netting until the uppermost liner sheet is lifted from the next lower liner sheet.

U.S. Pat. No. 5,983,832 discloses a cat litter box with bag system comprising a pan. A litter disposal bag is nested into the pan. A plurality of feces disposal bags are nested into the pan over the litter disposal bag. A protective insert having an open bottom is nested into the pan over the uppermost feces disposal bag. When a quantity of litter is placed into the pan and used by a cat to deposit feces, the protective insert can be withdrawn and each feces disposal bag can be removed one at a time as needed to separate the feces from the litter, then tied and discarded.

U.S. Pat. No. 6,595,159 discloses a bag sifting system, for use with a cat litter box in separating waste products and clumped litter from uncontaminated litter, using a plurality of bags which are extended over the litter box before the litter box is filled with litter. As the litter becomes partially soiled, an uppermost of the bags is lifted from the litter box. Each bag has a sifting region having a plurality of sifting holes which allow uncontaminated litter to fall onto the remaining bags in the litter box below. The waste products and clumped litter, being too large to fall through the sifting holes, remains in the bag.

U.S. Pat. No. 3,809,013 discloses an insert for placement in an open, self-supporting tray for use as an animal litter box. A number of disposable screens are stacked on top of each other, constructed of flat, thin flexible material such as paper or plastic film, include a plurality of holes at their center portion and are placed in the tray so that walls of the tray fold the screens into a receptacle. Means is provided for closing the holes in the screens to prevent articles from entering the holes and for opening them upon lifting a screen from the stack. To change the liner and dispose of waste, the top liner is lifted whereby litter sifts through the holes onto the remaining screens for reuse while the liner and the waste thereon are discarded.

All documents cited herein are incorporated by reference.

None of the above cited documents, alone or in combination satisfy the need for a kit of disposable filters that makes cleaning cat litter boxes easier and more hygienic.

### BRIEF SUMMARY

It is an object of the invention to provide a kit of replaceable cat litter filters and method of using same.

In accordance with an aspect of the invention there is provided a kit of filter sheets, for cleaning a cat litter box, said kit comprising: a plurality of filter sheets, sized and proportioned to fit within said cat litter box, stacked in a laminar orientation thereby presenting an upper filter sheet, a lower filter sheet and mid-level filter sheets, each of said filter sheets consisting of a central portion and an edge portion surrounding said central portion; a plurality of perforations situated within and extending through said central portion; and a drawstring installed in a functional relationship with said edge portion, wherein when the plurality of filter sheets are installed within said cat litter box, and clean cat litter is placed on top of said upper filter sheet, after some of said clean cat litter has been soiled, said drawstring on said upper sheet is tightened causing soiled cat litter to be retained within said upper filter sheet, said clean cat litter to pass through said perforations in said central portion of the upper filter sheet onto the lower subsequent filter sheets.

In accordance with another aspect of the invention there is provided a method of separating soiled clumped cat litter from clean cat litter, said method comprising the steps: installing the kit as described above into the base of an empty cat litter box; pouring clean cat litter on top of the upper filter sheet; lifting edge portion of said upper filter sheet; pulling and tightening said drawstring, thereby encompassing said soiled clumped cat litter in said upper filter sheet; lifting upper filter sheet encompassing soiled clumped cat litter, thereby allowing clean cat litter to fall through said perforations, and disposing of upper filter sheet encompassing soiled clumped cat litter.

In accordance with an additional aspect of the invention there is provided a method of separating soiled clumped cat litter from clean cat litter, said method comprising the steps: installing the kit as described above into the base of an empty cat litter box; securing said lower filter sheet to said an upper lipped edge of said cat litter box; pouring clean cat litter on top of the upper filter sheet; lifting edge portion of said upper filter sheet; pulling and tightening said drawstring, thereby encompassing said soiled clumped cat litter in said upper filter sheet; lifting upper filter sheet encompassing soiled clumped cat litter, thereby allowing clean cat litter to fall through said perforations, and disposing of upper filter sheet encompassing soiled clumped cat litter.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and B illustrate a top schematic view of an aspect of the subject matter in accordance with one embodiment of the invention.

FIG. 2 illustrates a perspective aspect of the type of cat litter box to be used in conjunction with one embodiment of the invention.

FIG. 3A and B illustrate a top schematic view of an aspect of the subject matter in accordance with an alternative embodiment of the invention.

FIG. 4 illustrates a perspective aspect of the type of cat litter box to be used in conjunction with an alternative embodiment of the invention.

FIG. 5 illustrates a perspective aspect of an embodiment of the invention in place within a rectangular cat litter box.

FIG. 6 illustrates a perspective aspect of the cat litter sheet in accordance with one embodiment of the invention.

FIG. 7 illustrates a perspective aspect of the cat litter sheet in accordance with one embodiment of the invention.

FIG. 8 illustrates an aspect of the subject matter in accordance with a material used in an alternative embodiment of the invention.

FIG. 9A and B illustrate an aspect of the subject matter in accordance with an alternative embodiment of the invention.

FIG. 10A and B illustrate an aspect of the use of the subject matter in accordance with an alternative embodiment of the invention.

### DETAILED DESCRIPTION

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

Various embodiments of the invention relate to a filter sheet 104 of material or mesh that can be gathered to form an enclosed bag by use of a drawstring 110. The drawstring 110 can be threaded through the perimeter of the mesh or within an edge seam 108. Typically, the filter sheet 104 extends across the flat base 210 of the litter box and up the vertical sides 208 and over the lipped edges of litter box 204.

Optimally, a plurality of the filter sheets 104 are installed, in a planar relationship, within the cat litter box. The cat litter is tipped onto the uppermost filter sheet 104. When the cat litter is soiled, the uppermost sheet is removed by selecting the drawstring 110 on the uppermost filter sheet 104, and pulling the drawstring to close the filter sheet 104 into an enclosed bag. The soiled clumped cat litter remains in the enclosed bag and the clean non-clumped cat litter falls onto the subsequent filter sheet 104.

There are numerous benefits associated with the various embodiments of the invention. Including the ability to clean cats litter boxes in less than 15 seconds and not have to breathe in the dust of the litter or get your hands accidentally dirty. By placing multiple bags in the litter box, you clean the litter box by removing the top filter sheet 104 in the stack lifting it up and pulling the drawstring closed.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

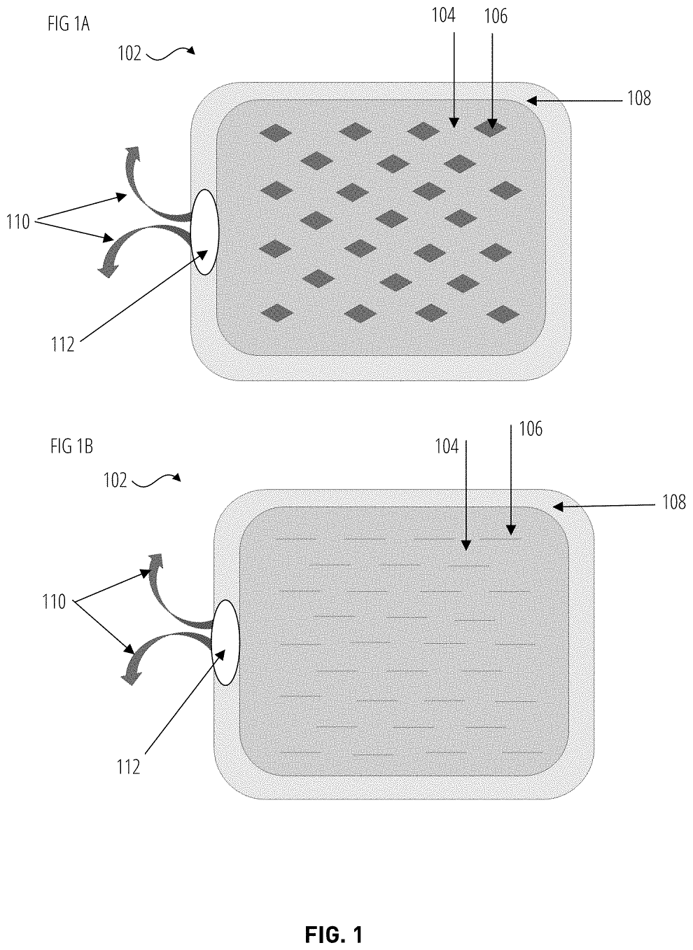

FIG. 1A and B illustrates a top view of two different embodiments of the invention.

FIG. 1A shows a replaceable rectangular cat litter sheet 102 comprising a filter sheet 104 having a series of perforations 106. In this particular embodiment, the perforations 106 are slits in the fabric of the filter sheet 104. The filter sheet 104 has an edge seam 108 around the circumference of the filter sheet 104. A drawstring 110 is situated within the edge seam 108, the ends of the drawstring 110 protrude through an opening 112.

FIG. 1B shows a similar replaceable rectangular cat litter sheet 102 comprising a filter sheet 104 having a series of perforations 106. In this particular embodiment, the perforations 106 are diamond shaped holes in the fabric of the filter sheet 104. The filter sheet 104 has an edge seam 108 around the circumference of the filter sheet 104. A drawstring 110 is situated within the edge seam 108, the ends of the drawstring 110 protrude through an opening 112.

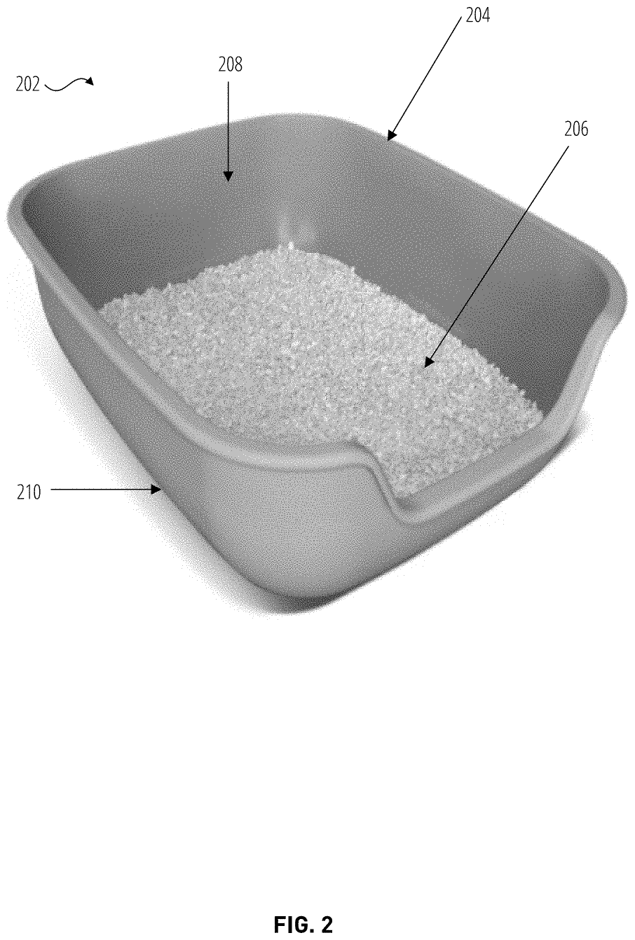

FIG. 2 shows a typical known rectangular cat litter box 202 that can be used in conjunction with an embodiment of the invention. The rectangular cat litter box 202 shown has a flat base 210, vertical sides 208 with lipped edges of litter box 204. The cat litter 206 is emptied onto the flat base 210 of the rectangular cat litter box 202.

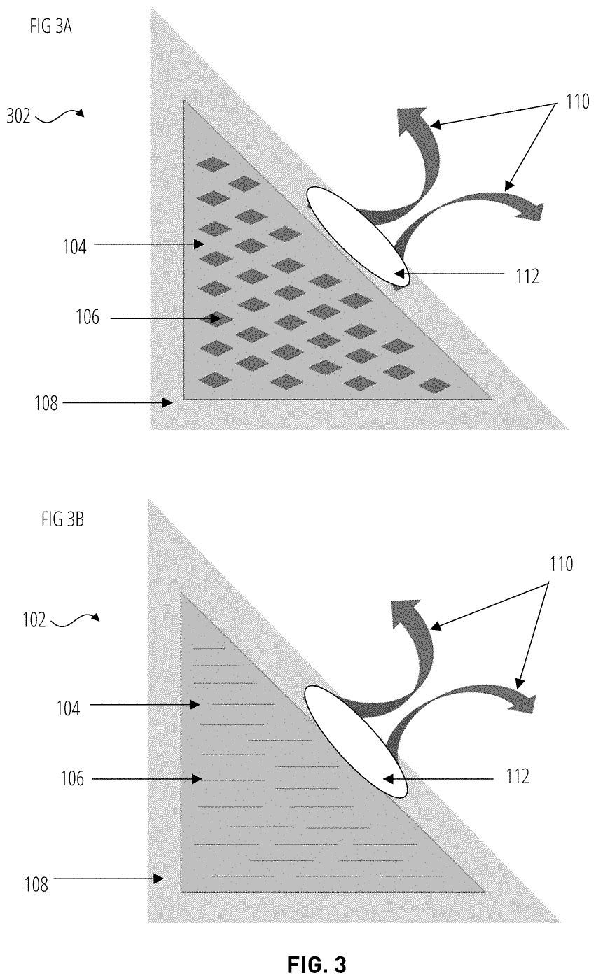

FIG. 3A and B illustrates a top view of two different embodiments of the invention.

FIG. 3A shows a replaceable triangular cat litter sheet 302 comprising a filter sheet 104 having a series of perforations 106. In this particular embodiment, the perforations 106 are slits in the fabric of the filter sheet 104. The filter sheet 104 has an edge seam 108 around the circumference of the filter sheet 104. A drawstring 110 is situated within the edge seam 108, the ends of the drawstring 110 protrude through an opening 112.

FIG. 3B shows a similar replaceable triangular cat litter sheet 302 comprising a filter sheet 104 having a series of perforations 106. In this particular embodiment, the perforations 106 are diamond shaped holes in the fabric of the filter sheet 104. The filter sheet 104 has an edge seam 108 around the circumference of the filter sheet 104. A drawstring 110 is situated within the edge seam 108, the ends of the drawstring 110 protrude through an opening 112.

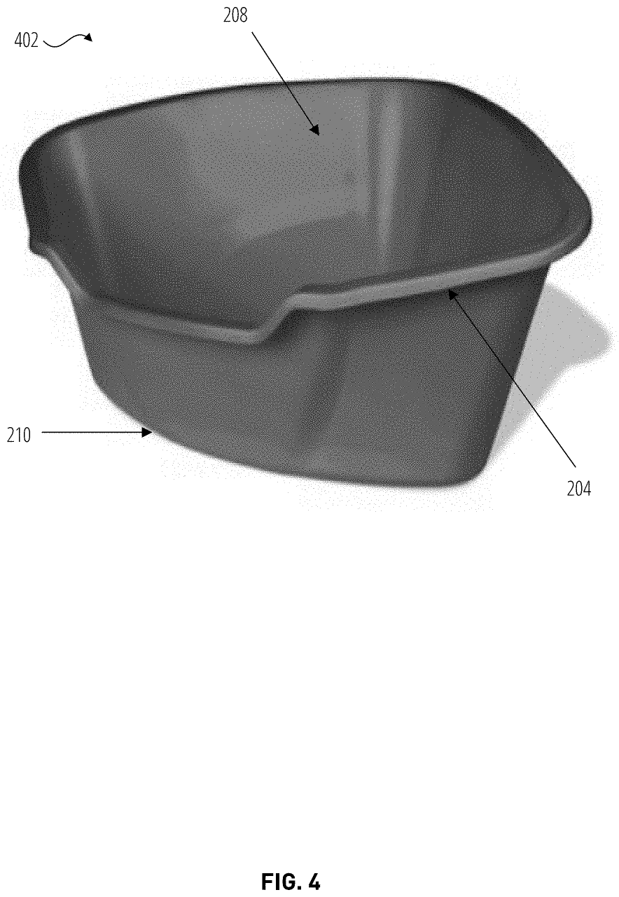

FIG. 4 shows a typical known triangular cat litter box 402 that can be used in conjunction with an embodiment of the invention. The triangular cat litter box 402 shown has a flat base 210, vertical sides 208 with lipped edges of litter box 204. The cat litter 206 is emptied onto the flat base 210 of the triangular cat litter box 402.

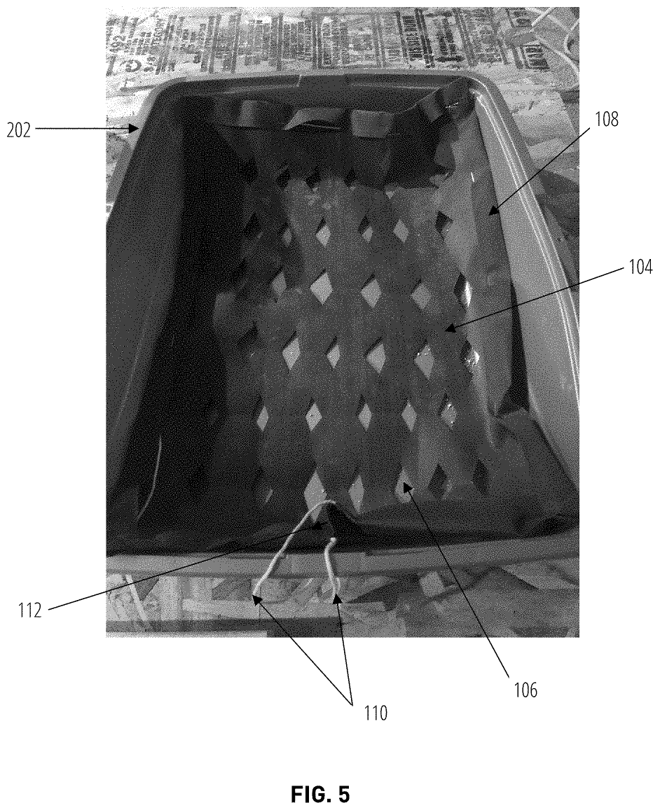

FIG. 5 shows a prototype of an embodiment of the invention. A filter sheet 104 containing numerous perforations 106 can be seen placed in the flat base 210 of a rectangular cat litter box 202. The filter sheet 104 has an edge seam 108 that runs around its circumference. A drawstring 110 is threaded through the edge seam 108 and protrudes out through an opening 112 in the edge seam 108. Cat litter 206 is tipped onto the filter sheet 104, for latter removal when soiled.

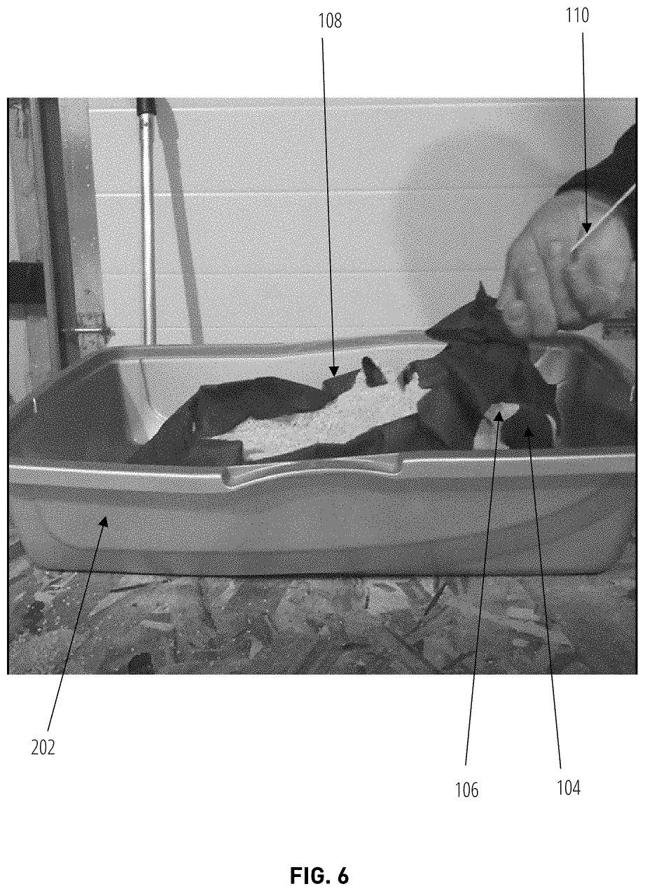

FIG. 6 shows a side view of an embodiment of the invention during use. After the cat litter 206 shown in FIG. 5 has been soiled, it can readily be removed by pulling on the drawstring 110. The clean cat litter 206 falls through the perforations 106 and the soiled, clumped cat litter 206 remains encompassed by the filter sheet 104, and secured by the drawstring 110.

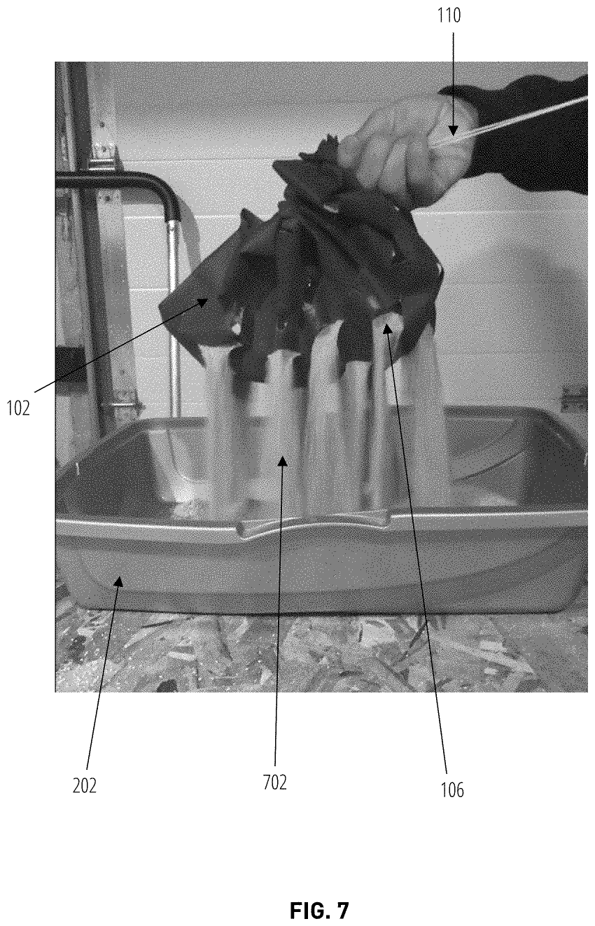

FIG. 7 shows a side view of a further view of the embodiment of the invention during use. After the replaceable rectangular cat litter sheet 102 shown in FIG. 6 has been soiled, it can readily be removed by pulling on the drawstring 110. The clean, clean non-clumped litter 702 falls through the perforations 106 and the soiled, clumped cat litter 206 remains encompassed by the filter sheet 104, and secured by the drawstring 110.

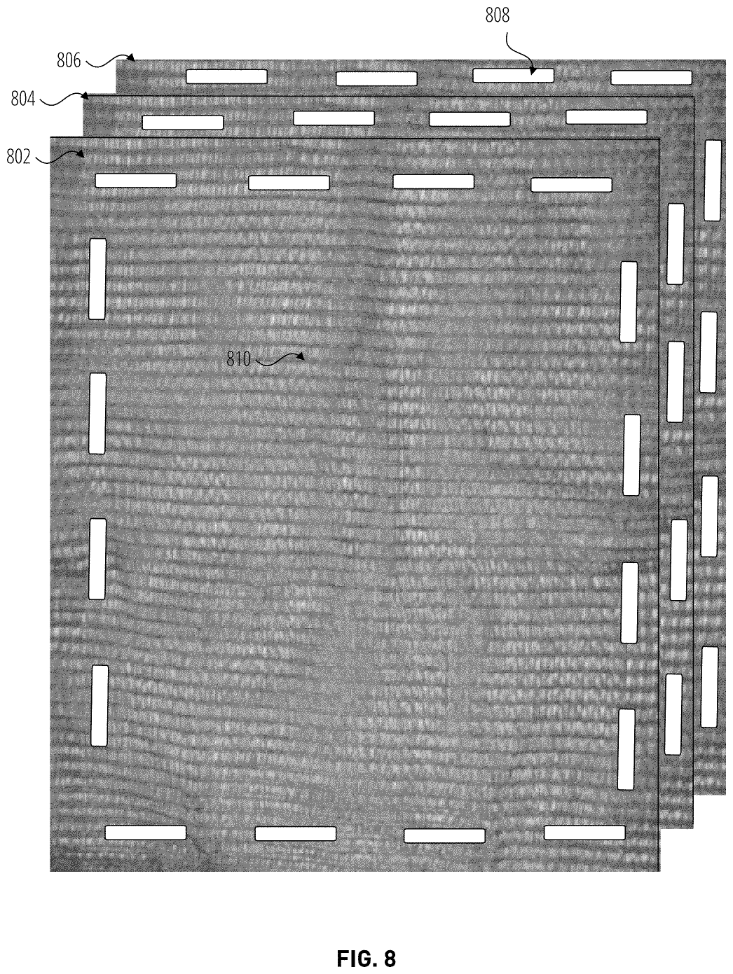

FIG. 8 illustrates a mesh sheet 810 embodiment of the invention. In this particular embodiment, a continuous drawstring 808 is woven around the perimeter of the mesh sheet 810. The illustrated embodiment relates to rectangular mesh sheets sized and proportioned to fit a regular rectangular cat litter box. A plurality of mesh sheets are stacked in a planar relationship, for example, an uppermost filter sheet 802 and a second filter sheet 804 and a third filter sheet 806 plus a plurality of subsequent sheets (not shown).

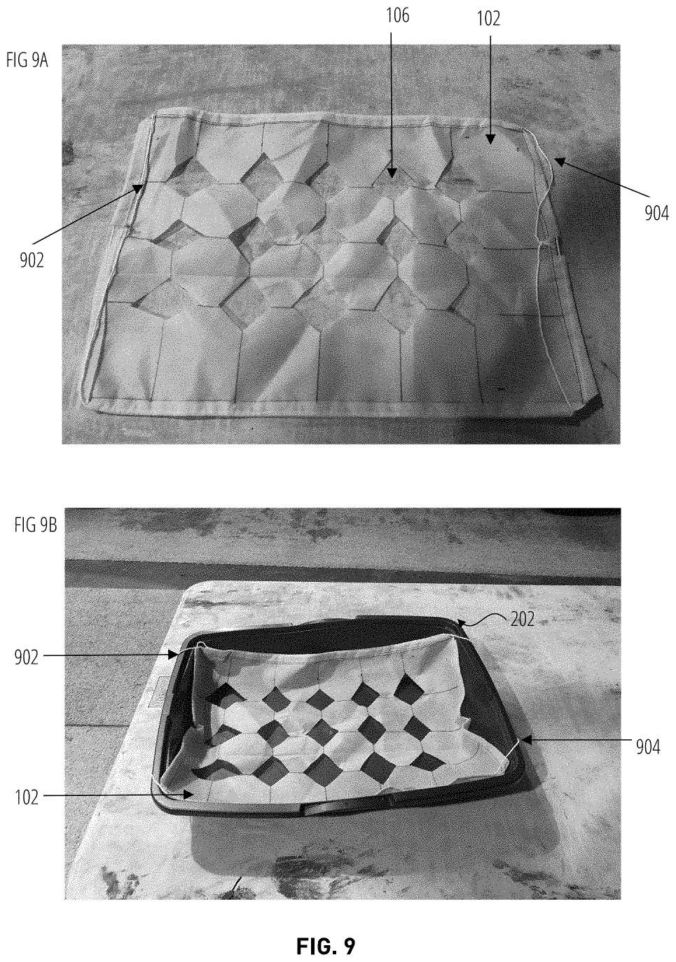

FIG. 9A and B show an alternative embodiment of the invention wherein the replaceable rectangular cat litter sheet 102 has a continuous drawstring 808 threaded into an edge seam 108.

FIG. 9A illustrates the positioning of continuous drawstring 808 on a replaceable rectangular cat litter sheet 102. It can be seen that the continuous drawstring 808 can be pulled, for example, at the first side of continuous drawstring 902 and at the second side of continuous drawstring 904.

FIG. 9B illustrates the positioning of a replaceable rectangular cat litter sheet 102 having a continuous drawstring 808 in a rectangular cat litter box 202. The first side of continuous drawstring 902 being installed at a first end of the rectangular cat litter box 202, and the second side of continuous drawstring 904 is installed at the second end of the rectangular cat litter box 202.

It will be readily recognized that the continuous drawstring 808 can be pulled through gaps formed at various places around the perimeter of the replaceable cat litter sheet. The positioning of the gaps being dependent upon the shape of the cat litter box.

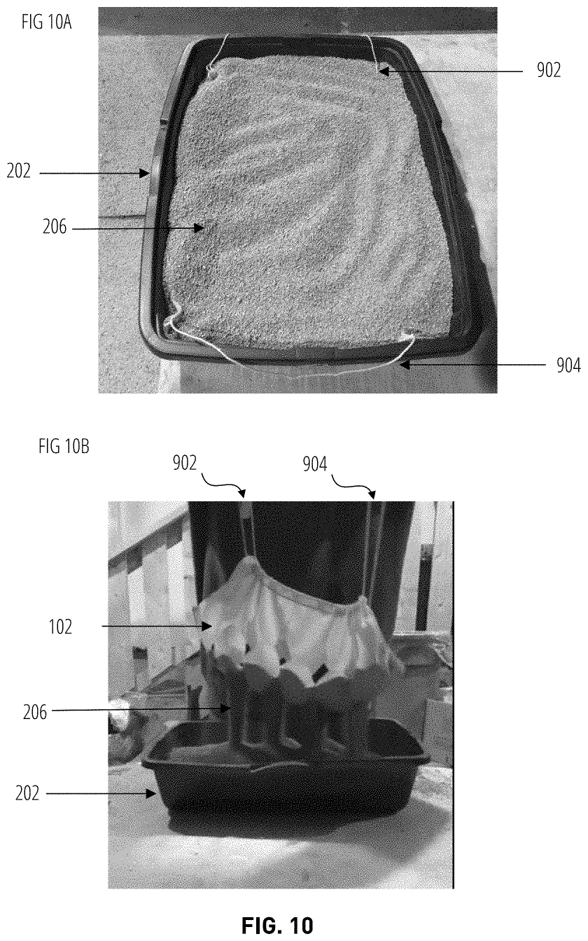

FIG. 10A and B show the alternative embodiment of the invention with the replaceable rectangular cat litter sheet 102 having the continuous drawstring 808 threaded into an edge seam 108 in use in a rectangular cat litter box 202.

FIG. 10A illustrates the positioning of a replaceable rectangular cat litter sheet 102 having a continuous drawstring 808 in a rectangular cat litter box 202 that has been filled with cat litter 206. The first side of continuous drawstring 902 being visible at a first end of the rectangular cat litter box 202, and the second side of continuous drawstring 904 being visible at the second end of the rectangular cat litter box 202.

FIG. 10B illustrates the operation of the alternative embodiment of the invention with the replaceable rectangular cat litter sheet 102 having the continuous drawstring 808. When the cat litter 206 has been used, the cat owner can grasp the first side of continuous drawstring 902 and the second side of continuous drawstring 904 and lift the replaceable rectangular cat litter sheet 102. The clean cat litter 206 will fall through the perforations 106 into the cat litter box.

The embodiments of the invention illustrated in the FIGS are rectangular or essentially triangular. Various shapes and sizes of filter sheets are considered within the scope of protection sought to fit various shapes and sizes of litter boxes.

It is contemplated that a commercial embodiment of embodiments of the invention is to supply the filter sheets 104 as a kit. In essence, a number of filter sheets 104 would be supplied stacked in a laminar or planar configuration, or they could be supplied in a format where multiple filter sheets 104 are supplied in a roll. The filter sheets 104 may be releasably clipped together for ease of handling prior to installation within the cat litter box.

In some embodiments of the invention, the lowermost sheet is sized and proportioned such that it extends up the vertical sides 208 of the cat litter box and over the lipped edges of litter box 204. The drawstring 110 may then be fastened in place around the litter box with the drawstring 110 cooperating with the lipped edges of litter box 204. In an alternative embodiment, the drawstring 110 on the lowermost sheet may be elasticated. This particular embodiment results in all of the filter sheets 104 being positioned above the level of the cat litter 206, resulting in a cleaner and more hygienic soiled litter removal process.

Other important features of embodiments of the invention relate to the materials selected to produce the filter sheets 104 and drawstrings 110. It is preferred that materials are chosen that are recyclable, biodegradable, compostable and therefore easily disposable in an environmentally friendly manner. Such materials can include, but are not limited to, polypropylene, bamboo, bioplastics, soybean, potato, avocado, nopal and other vegetable, plant or fruit-based plastics, mycelium polymer-based materials, seaweed polymers and hemp.

The drawstrings 110 may be a continuous drawstring 808, or it may be a single length of material, that encompasses the entire replaceable cat litter sheet. When the drawstring 110 is a continuous drawstring 808, it may be pulled together through a single opening 112 in the edge seam 108, or it may be pulled together through two opposing openings 112. When the drawstring 110 is a single length of material, then the opposing ends of the material are simultaneously pulled together through a single opening 112 in the edge seam 108.

Different types of cat litters that can be used in conjunction with the various embodiments of the invention. Clay based litters can are non-biodegradable. Cat litters that are composed of compressed paper, wood shavings, corn or wheat husks, and sawdust are preferable for use in compost piles. Compost made of pet waste however is to be used only on lawns or non-edible crops such as flower beds.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A kit of filter sheets, for cleaning a cat litter box, said kit comprising:
a plurality of filter sheets, sized and proportioned to fit within said cat litter box, stacked in a laminar orientation thereby presenting an upper filter sheet, a lower filter sheet and mid-level filter sheets, each of said filter sheets consisting of a central portion and an edge portion surrounding said central portion;
a plurality of perforations situated within and extending through said central portion; and
a drawstring installed in a functional relationship with said edge portion,
wherein when the plurality of filter sheets is installed within said cat litter box, and clean cat litter is placed on top of said upper filter sheet, after some of said clean cat litter has been soiled, said drawstring on said upper sheet is tightened causing soiled cat litter to be retained within said upper filter sheet, said clean cat litter to pass through said perforations in said central portion of the upper filter sheet onto the lower subsequent filter sheets.

2. The kit of claim 1, wherein said plurality of filter sheets, sized and proportioned to fit within a rectangular cat litter box.

3. The kit of claim 1, wherein said plurality of filter sheets, sized and proportioned to fit within a triangular cat litter box.

4. The kit of claim 1, wherein said plurality of filter sheets, sized and proportioned to fit within a square cat litter box.

5. The kit of claim 1, wherein said perforations are slits.

6. The kit of claim 1, wherein said perforations are holes selected from the group comprising: circular; oval; square; rectangular; and diamond.

7. The kit of claim 1, wherein said central portion of said filter sheets is comprised of a net or mesh.

8. The kit of claim 1, wherein said lower filter sheet is adapted to engage with an upper lipped edge of said cat litter box.

9. The kit of claim 1, wherein said filter sheets are comprised of a compostable or biodegradable material.

10. The kit of claim 1, wherein said drawstring is continuous.

11. The kit of claim 9, wherein said compostable or biodegradable material are selected from the group comprising of: polypropylene; bamboo; bioplastics; soy bean, potato, avocado, nopal and other vegetable, plant or fruit-based plastics; mycelium polymer-based materials;
seaweed polymers; and hemp.

12. The kit of claim 1, wherein said plurality of filter sheets in said kit are releasably connected together.

13. The kit of claim 1, wherein said plurality of filter sheets in said kit are rolled into a cylindrical shape for ease of handling and distribution.

14. A method of separating soiled clumped cat litter from clean cat litter, said method comprising the steps:
installing the kit of claim 1 into the base of an empty cat litter box;
pouring clean cat litter on top of the upper filter sheet;
lifting edge portion of said upper filter sheet;
pulling and tightening said drawstring, thereby encompassing said soiled clumped cat litter in said upper filter sheet;
lifting upper filter sheet encompassing soiled clumped cat litter, thereby allowing clean cat litter to fall through said perforations, and
disposing of upper filter sheet encompassing soiled clumped cat litter.

15. The method of claim 14, wherein said plurality of filter sheets are comprised of a compostable or biodegradable material.

16. The method of claim 14, wherein said step of disposing of said soiled clumped cat litter consists of the recycling or composting said soiled clumped cat litter.

17. The method of claim 14, wherein said drawstring is continuous.

18. A method of separating soiled clumped cat litter from clean cat litter, said method comprising the steps:
installing the kit of claim 8 into the base of an empty cat litter box;
securing said lower filter sheet to said an upper lipped edge of said cat litter box;
pouring clean cat litter on top of the upper filter sheet;
lifting edge portion of said upper filter sheet;
pulling and tightening said drawstring, thereby encompassing said soiled clumped cat litter in said upper filter sheet;
lifting upper filter sheet encompassing soiled clumped cat litter, thereby allowing clean cat litter to fall through said perforations, and
disposing of upper filter sheet encompassing soiled clumped cat litter.

19. The method of claim 18, wherein said drawstring is continuous.
